(19) United States
(12) Patent Application Publication
(10) Pub. No.: US 2016/0055242 A1
(43) Pub. Date: Feb. 25, 2016

(54) SYSTEMS AND METHODS FOR ANALYZING CONTENT FROM DIGITAL CONTENT SOURCES

(71) Applicant: Luceo Social, Inc., Renton, WA (US)

(72) Inventors: Ljubomir Bradic, Seattle, WA (US); Robert D. Whitley, North Bend, WA (US); Kelly Kolb, Seattle, WA (US)

(21) Appl. No.: 14/831,791

(22) Filed: Aug. 20, 2015

Related U.S. Application Data
(60) Provisional application No. 62/039,869, filed on Aug. 20, 2014.

(51) Int. Cl. G06F 17/30

(52) U.S. Cl. CPC G06F 17/30864; G06F 17/3053

(57) ABSTRACT

Methods and systems are provided for analyzing content items from digital content sources with respect to activity on communication networks. Content items are retrieved based on tracking set definitions from digital content sources via a network, and metadata is extracted from the retrieved content items. Communication related to the content items on one or more communication networks is periodically monitored, and the monitored communication is used to generate content scores for the retrieved content items based on one or more static content scores, dynamic content scores, and contextual relevance scores. The periodic monitoring allows trending information with respect to content items, authors, topics, and/or other data elements to be surfaced and analyzed.

### CROSS-REFERENCE TO RELATED APPLICATION

This application claims the benefit of Provisional Application No. 62/039,869, filed Aug. 20, 2014, the entire disclosure of which is hereby incorporated by reference herein for all purposes.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a system for analyzing digital content on a network is provided. The system comprises at least one computing device configured to provide a content retrieval engine, at least one computing device configured to provide a communication monitoring engine, and at least one computing device configured to provide a content scoring engine. The content retrieval engine is configured to retrieve content items from one or more content sources. The communication monitoring engine is configured to query one or more communication networks for information regarding communication related to the retrieved content items. The content scoring engine is configured to determine content scores for the retrieved content items based at least on the information regarding communication related to the retrieved content items.

In some embodiments, a computer-implemented method for identifying trends on a network is provided. A computing device retrieves a set of content items from one or more content sources via a network. A computing device monitors communication related to the retrieved set of content items on one or more communication networks during a given time frame. A computing device determines a score for each content item of the retrieved set of content items based at least on the monitored communication during the given time frame; and a computing device presents an interface based on the retrieved set of content items having highest scores.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates an exemplary embodiment of a content analysis system according to various aspects of the present disclosure;

FIGS. 2A-2B are a flowchart that illustrates an exemplary embodiment of a method of gathering content for analysis from digital content sources according to various aspects of the present disclosure;

FIGS. 3A-3B are a flowchart that illustrates an exemplary embodiment of a method of analyzing content from digital content sources according to various aspects of the present disclosure;

FIGS. 4A-4D are illustrations of exemplary embodiments of presentations of content scores and their component parts according to various aspects of the present disclosure;

FIG. 5 is a flowchart that illustrates an exemplary embodiment of a method of querying for trending digital content according to various aspects of the present disclosure;

FIG. 6 is an illustration of an exemplary embodiment of a query result display generated by the interface engine according to various aspects of the present disclosure;

FIG. 7 is another illustration of an exemplary embodiment of a query result display generated by the interface engine according to various aspects of the present disclosure;

FIG. 8 is an illustration of another exemplary embodiment of a query result display generated by the interface engine according to various aspects of the present disclosure; and

FIG. 9 is a block diagram that illustrates aspects of an exemplary computing device 900 appropriate for use with embodiments of the present disclosure.

### DETAILED DESCRIPTION

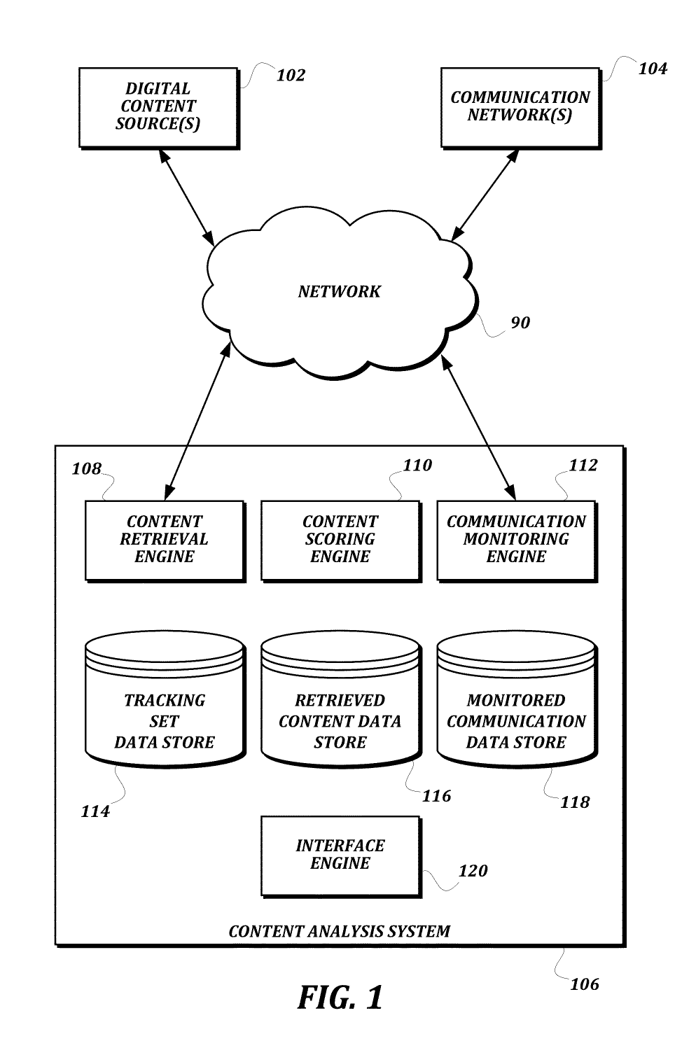

FIG. 1 is a block diagram that illustrates an exemplary embodiment of a content analysis system according to various aspects of the present disclosure. As illustrated, the content analysis system 106 includes a content retrieval engine 108, a communication monitoring engine 112, a content scoring engine 110, and an interface engine 120.

In general, the word “engine,” as used herein, refers to logic embodied in hardware or software instructions, which can be written in a programming language, such as C, C++, COBOL, JAVA™, PHP, Perl, HTML, CSS, JavaScript, VBScript, ASPX, Microsoft .NET™, and/or the like. An engine may be compiled into executable programs or written in interpreted programming languages. Engines may be callable from other engines or from themselves. The engines described herein refer to modules that can be merged with other engines, or can be divided into sub-engines. The engines can be stored in any type of computer-readable medium or computer storage device and be stored on and executed by one or more general purpose computers, thus creating a special purpose computer configured to provide the engine. As such, one of ordinary skill in the art will recognize that use of the term “engine” is essentially a simplified way of describing a particular computing device configured to perform the actions attributed to the “engine” through the execution of computer-executable instructions that cause such actions to be performed.

The content retrieval engine 108 is configured to retrieve content items from one or more digital content sources 102. The content retrieval engine 108 accesses the digital content sources 102 over a network 90 such as the Internet or any other wide area network or local area network. The digital content sources 102 may provide any type of digital content items, including but not limited to web pages; blog posts; video and/or audio files; video and/or audio streams; image files; UseNet news posts; and formatted documents such as XML documents, PDF files, PostScript files, Microsoft Word, Excel, Powerpoint files; and/or the like. Though a single content retrieval engine 108 is illustrated, multiple content retrieval engines 108 may be present and may operate in parallel in order to retrieve content at a faster rate. How the content retrieval engine 108 determines what content to obtain is discussed further below.

The communication monitoring engine 112 is configured to retrieve information via the network 90 from one or more communication networks 104. The communication networks 104 include any communication network on which a digital content source 102 may be referenced in a communication detectable by the communication monitoring engine 112. Some non-limiting examples of communication networks 104 include social networks such as Facebook, Twitter, LinkedIn, Pinterest, Google Plus, and/or the like; blog platforms such as Tumblr, Wordpress, Blogger, and/or the like; digital publishing platforms such as Kinja, Chorus, and/or the like; application distribution networks such as the Apple App Store, the Google Play Store, the Microsoft Store, and/or the like; messaging platforms such as e-mail, iMessage, SMS messaging, and/or the like; web comment platforms such as Disqus and/or the like; and/or any other type of communication network 104 on which content items may be mentioned.

In some embodiments, the communication network 104 may be separate from the digital content source 102. For example, if a web page from “example.com” is retrieved as a content item from a digital content source 102, and the monitored communication on a communication network 104 is a Facebook status update with a link to the web page from “example.com,” the digital content source 102 (“example.com”) and the communication network 104 (Facebook) are clearly separate. In some embodiments, the communication network 104 may overlap the digital content source 102. For example, if a blog post is retrieved as a content item from a digital content source 102, and a comment posted directly to the blog post is the monitored communication on the communication network 104, the blog may be considered to be both the digital content source 102 and the communication network 104.

The content scoring engine 110 is configured to determine scores for one or more retrieved content items based on information retrieved from the one or more communication networks 104 regarding communications related to the retrieved content items. The interface engine 120 is configured to generate a graphical user interface (GUI) and/or provide an application programming interface (API) that allows access to the functionality of the content analysis system 106. Detailed description of the functionality of the content scoring engine 110 and the interface engine 120 is provided below.

As illustrated, the content analysis system 106 also includes a tracking set data store 114, a retrieved content data store 116, and a monitored communication data store 118. As understood by one of ordinary skill in the art, a “data store” as described herein may be any suitable device configured to store data for access by a computing device. One example of a data store is a highly reliable, high-speed relational database management system (RDBMS) executing on one or more computing devices and accessible over a high-speed network. However, any other suitable storage technique and/or device capable of quickly and reliably providing the stored data in response to queries may be used, such as a key-value store, an object database, and/or the like.

Further, the computing device providing the data store may be accessible locally instead of over a network, or may be provided as a cloud-based service. A data store may also include data stored in an organized manner on a computer-readable storage medium, as described further below. Another example of a data store suitable for use with embodiments of the present disclosure is a file system or database management system that stores data in files (or records) on a computer readable medium such as flash memory, random access memory (RAM), hard disk drives, and/or the like. One of ordinary skill in the art will recognize that separate data stores described herein may be combined into a single data store, and/or a single data store described herein may be separated into multiple data stores, without departing from the scope of the present disclosure.

The tracking set data store 114 is configured to store one or more tracking set definitions, the contents and use of which will be discussed in further detail below. The retrieved content data store 116 is configured to store at least a portion of content items retrieved by the content retrieval engine 108. The stored portion of the content items may subsequently be used for score calculation, for presenting cached versions of portions of the content items, or for any other purpose. The monitored communication data store 118 stores records of communication detected by the communication monitoring engine 112 that relate to the content items. Further details about the information stored in the retrieved content data store 116 and the monitored communication data store 118 are described below.

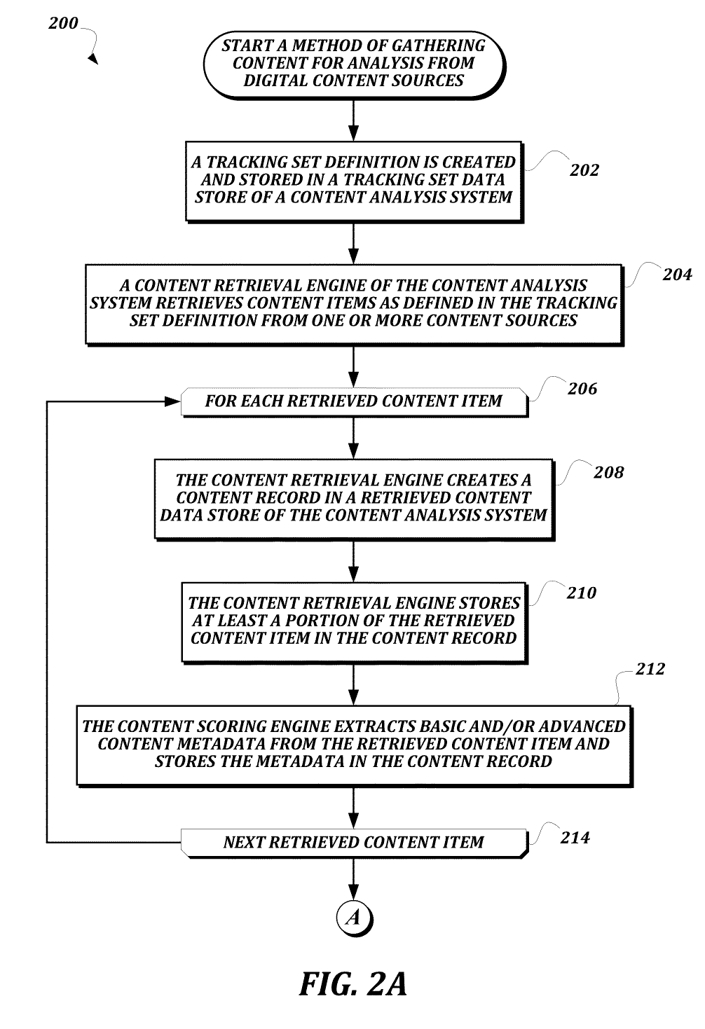

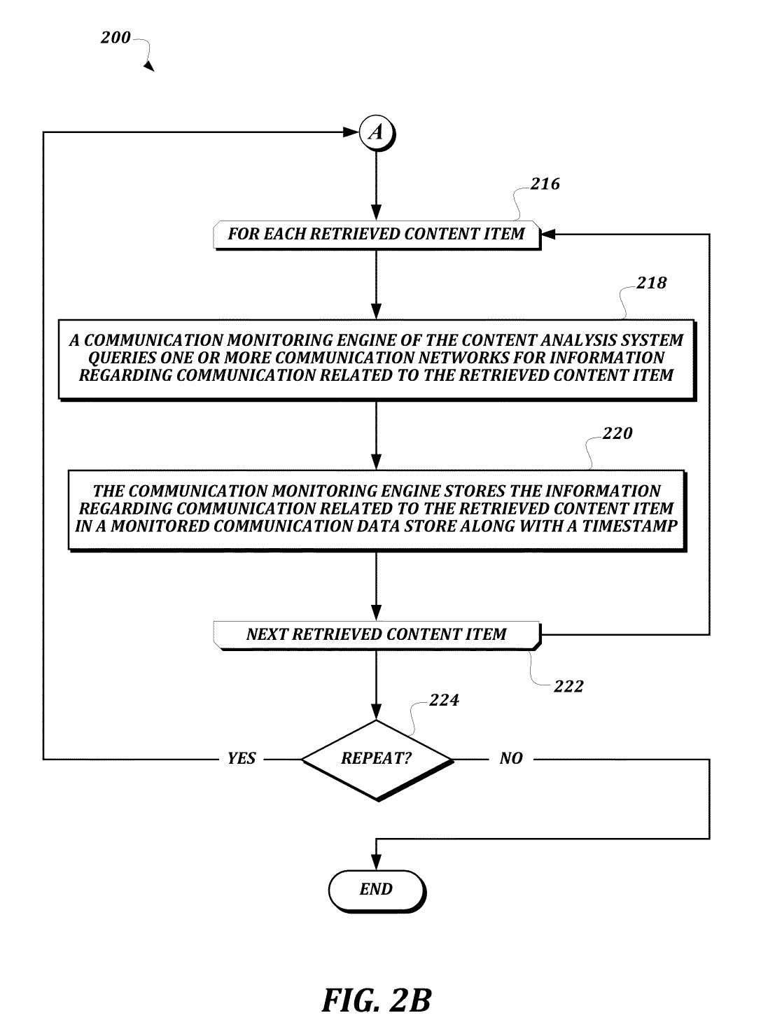

FIGS. 2A-2B are a flowchart that illustrates an exemplary embodiment of a method of gathering content for analysis from digital content sources according to various aspects of the present disclosure. From a start block, the method 200 proceeds to block 202, where a tracking set definition is created and stored in a tracking set data store 114 of a content analysis system 106. In some embodiments, the tracking set definition may be created by an interaction with a GUI generated by the interface engine 120, or may be created by virtue of commands received by an API provided by the interface engine 120.

Each tracking set definition defines a set of content items from digital content sources 102 to be analyzed together in a group. In some embodiments, the tracking set definition may also identify one or more communication networks 104 to monitor for communication relating to the set of content items, a frequency at which communication networks 104 should be checked for communication for the set of content items, and/or other information relating to the tracking set definition. In some embodiments, the tracking set definition may not include identifications of communication networks 104, in which case the communication monitoring engine 112 may monitor all communication networks 104 known to it for the defined set of content items.

In some embodiments, a tracking set definition may include one or more of the following: a web URL (e.g., http://www.example.com/pagetotrack.html); a domain (e.g., http://www.example.com/); a portion of a web site (e.g., http://www.example.com/politics/); an RSS feed (e.g., http://www.example.com/rss.xml); a social feed (e.g., http://www.twitter.com/gov); a video channel (e.g., https://www.youtube.com/user/torontomapleleafs); a newsletter (e.g., an email newsletter to which the content retrieval engine 108 may be subscribed); and/or the like.

In some embodiments, the tracking set definition allows for the specification of more than one content item. Accordingly, a tracking set definition may be defined to allow group analysis of content sources in a variety of ways. For example, a tracking set definition may include multiple different domains owned or controlled by a single entity. As another example, a tracking set definition may include multiple competing domains in an industry area, or a panel of sites from a vertical (e.g., multiple political news web sites). In some embodiments, other combinations of content items, and/or combinations of different item types, may be included in a tracking set definition. In some embodiments, tracking set definitions may also include other nested tracking set definitions.

Next, at block 204, a content retrieval engine 108 of the content analysis system 106 retrieves content items as defined in the tracking set definition from one or more content sources 102. Each different type of content item defined in the tracking set definition may be handled in a different way by the content retrieval engine 108. For example, for a web URL, the content retrieval engine 108 may simply retrieve that single URL. As another example, for content items that serve as a reference to other content items, such as a domain, a portion of a web site, an RSS feed, a newsletter, a social feed, or a video channel, the content retrieval engine 108 may crawl the defined content item in order to find the complete list of content items (e.g., web URLs) to analyze. In some embodiments, a type of the content item (and therefore how the content retrieval engine 108 should treat the item) may be explicitly indicated in the tracking set definition.

The method 200 then proceeds to a for loop defined between a for loop entry block 206 and a for loop exit block 214 that is executed for each of the content items retrieved by the content retrieval engine 108 in block 204. One will note that each content source 102 defined in the tracking set definition may result in multiple content items being retrieved, such as a domain content item being crawled for individual web page content items present thereon. From the for loop entry block 206, the method 200 proceeds to block 208, where the content retrieval engine 108 creates a content record in a retrieved content data store 116 of the content analysis system 106. At block 210, the content retrieval engine 108 stores at least a portion of the retrieved content item in the content record. In some embodiments, the content retrieval engine 108 may store portions of the retrieved content item usable to calculate a content score, including but not limited to the raw content of the content item and/or the like. In some embodiments, the content retrieval engine 108 may store portions of the content item usable for other purposes, including but not limited to one or more linked images or other objects; a URL or other reference identifier usable to share or identify the content item; a timestamp of retrieval; a reference to the tracking set definition used to retrieve the content item; and/or the like.

At block 212, the content scoring engine 110 extracts basic and/or advanced content metadata from the retrieved content item and stores the metadata in the content record. In some embodiments, basic metadata may include content that is semantically indicated within the content item, such as within document metadata, HTTP headers, or the text of the document itself. For example, basic metadata may include, but is not limited to, a title, a description, an author, body text, a video type, a video play length, a language, and/or the like. In some embodiments, advanced metadata may include content that is not semantically indicated within the content item but can be extracted using natural language processing techniques. For example, basic metadata may include, but is not limited to, a topic of the content item, an entity referred to in the content item, and/or the like.

The method 200 then proceeds to the for loop exit block 214. If further content items remain to be processed, then the method 200 returns to the for loop start block 206. Otherwise, if all content items have been processed, then the method 200 proceeds to a continuation terminal (“terminal A”). From terminal A (FIG. 2B), the method 200 proceeds to a for loop defined between a for loop enter block 216 and a for loop exit block 222 that is executed for each of the retrieved content items, and is periodically repeated (as discussed below).

From the for loop enter block 216, the method 200 proceeds to block 218, where a communication monitoring engine 112 of the content analysis system 106 queries one or more communication networks 104 for information regarding communication related to the retrieved content item. In some embodiments, a communication network 104 may expose an API that allows the communication monitoring engine 112 to query for communication statistics associated with a content identifier such as a URL. For example, social networks such as Facebook and Twitter allow a query for a URL, and will return counts of likes, shares, and comments (in the case of Facebook), or of mentions, retweets, and favorites (in the case of Twitter). In some embodiments, a communication network 104 may allow the communication monitoring engine 112 to register a URL with the communication network 104 for monitoring by the communication network 104. For example, the communication monitoring engine 112 may register a trackback or other linkback URL with the communication network 104, and the communication network 104 will push information to the communication monitoring engine 112 using the URL. In some embodiments, the communication monitoring engine 112 crawls content on the communication network 104 in order to find relevant information.

At block 220, the communication monitoring engine 112 stores the information regarding communication related to the retrieved content item in a monitored communication data store 118 along with a timestamp. The timestamp indicates a point in time when the information was obtained by the communication monitoring engine 112, and/or a point in time when the stored information is considered accurate. In some embodiments, the information regarding communication related to the retrieved content item is a total count of all communication relating to the retrieved content item. In these embodiments, the timestamp will indicate at what point in time the stored total count was accurate.

The method 200 then proceeds to the for loop exit block 222. If further retrieved content items remain to be processed, then the method 200 returns to the for loop entry block 216. Otherwise, the method 200 proceeds to a decision block 224, where a determination is made regarding whether to repeat the monitoring of communication. In some embodiments, the monitoring of communication is performed repeatedly in order to establish trends over time. As such, the method 200 may pause a predetermined amount of time at decision block 224, and then perform the determination regarding whether to repeat. The pause may be determined such that the for loop entry block 216 will be entered at a predetermined interval, such as an hour after the previous entry to the for loop entry block 216, or any other suitable interval in order to obtain consistently spaced data points. In some embodiments, the method 200 may proceed with the determination at decision block 224 immediately in order to begin collecting additional information as soon as possible. In some embodiments, the method 200 may pause different lengths of time for processing different tracking set definitions, as indicated within the tracking set definitions. If it is determined that the monitoring of communication should be repeated (which would typically be the case while the content analysis system 106 is active), then the result of the determination at decision block 224 is YES, and the method 200 returns to terminal A. Otherwise, if the result of the determination at decision block 224 is NO, then the method 200 proceeds to an end block and terminates.

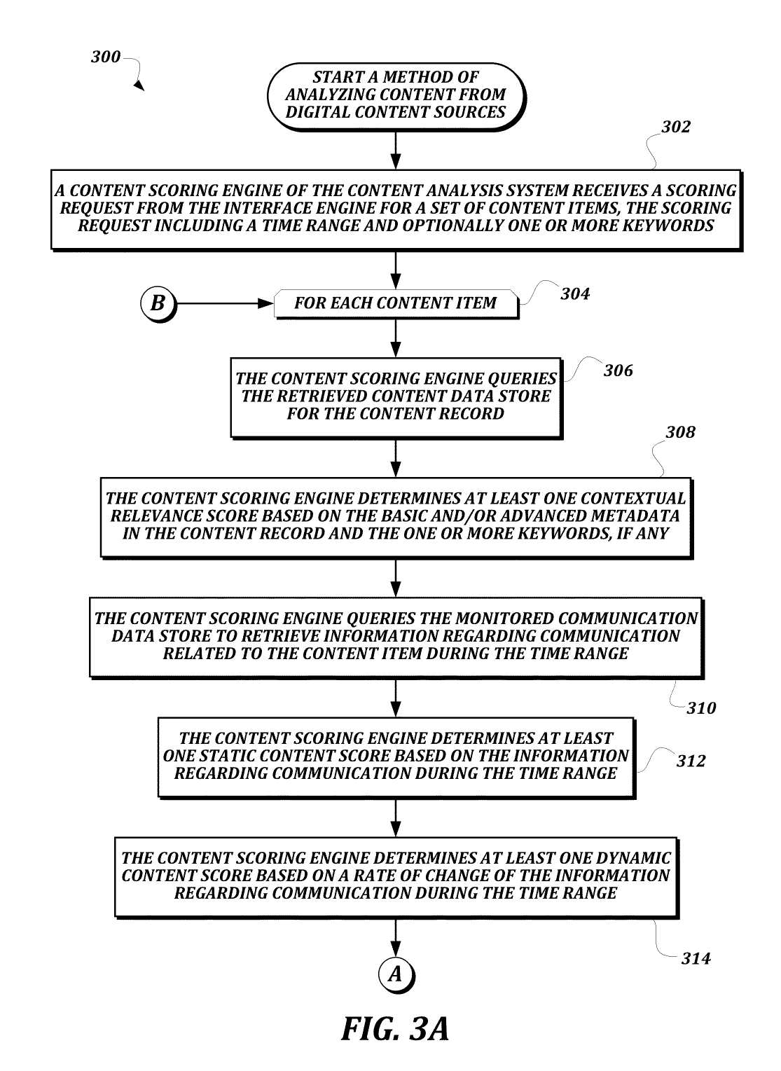

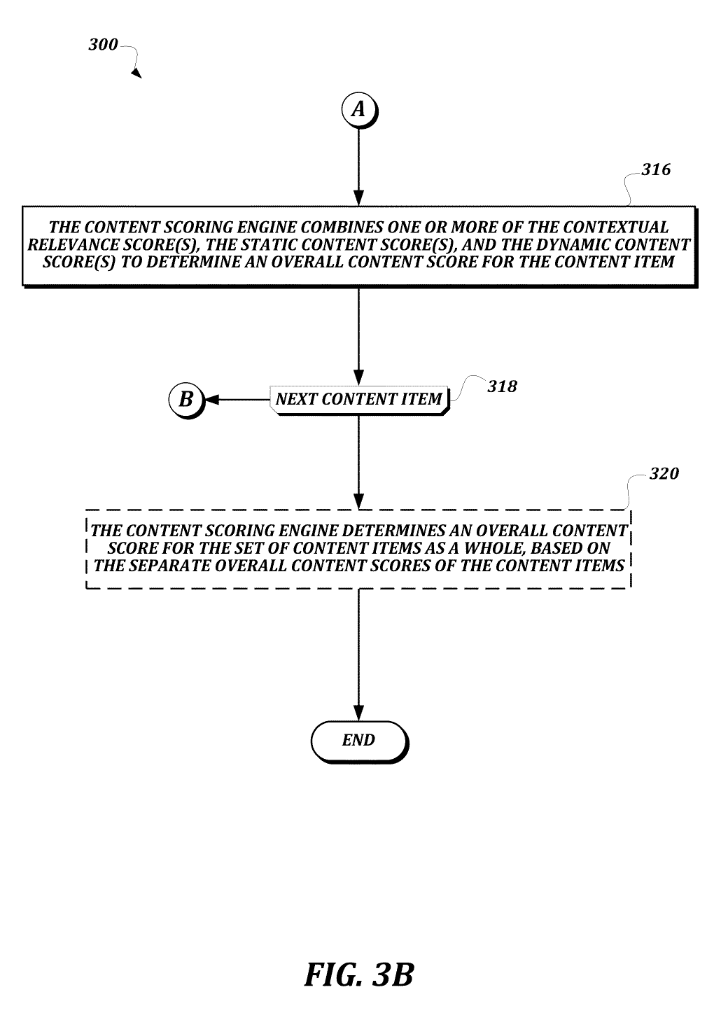

FIGS. 3A-3B are a flowchart that illustrates an exemplary embodiment of a method of analyzing content from digital content sources according to various aspects of the present disclosure. The result of the method 300 is the calculation of content scores that apply to one or more retrieved content items. In some embodiments, a content score is a weighted, time-specific range combination of one or more of static inputs, dynamic inputs, heuristics, and contextual relevance that provides an indication of importance for the one or more associated content items as discussed further below.

From a start block, the method 300 proceeds to block 302, where a content scoring engine 110 of the content analysis system 106 receives a scoring request from the interface engine 120 for a set of content items, the scoring request including a time range and optionally one or more keywords. The generation of a scoring request by the interface engine 120 will be discussed further below. The time range indicates what data will be considered by the content scoring engine 110. For example, the time range could be selected from possible values such as “last hour,” “last day,” “last seven days,” an explicit date range (e.g., Dec. 2, 2014 through Dec. 25, 2014), and/or the like. As another example, the time range could simply specify “all time,” in which case either all retrieved information or just information retrieved during a most recent update performed by the communication monitoring engine 112 would be considered.

If the keywords are present, they may be used as query terms to filter content items to be scored, or may be used to augment the calculated scores as outlined below. In some embodiments, the time range may also be optional, in which case either all available data is analyzed, all data since a most recent update is analyzed, or some other default subset of data is analyzed. In some embodiments, the scoring request may include a reference to a tracking set definition in order to indicate the desired set of content items, and the keywords, if present, may filter the content items that were retrieved using the tracking set definition.

The method 300 then proceeds to a for loop defined between a for loop entry block 304 and a for loop exit block 318 (see FIG. 3B) that is executed for each content item that matches the scoring request. If a reference to a tracking set definition was present, in the scoring request, then the set of content items that match the scoring request may be found by querying for retrieved content items that were retrieved using the tracking set definition. If the reference to the tracking set definition was not present, then all content items from the retrieved content data store 116 may be considered. In both cases, the keywords may be used to filter the retrieved content items to be scored.

From the for loop entry block 304, the method 300 proceeds to block 306, where the content scoring engine 110 determines at least one contextual relevance score based on the basic and/or advanced metadata in the content record and the one or more keywords, if any. The contextual relevance score reflects how similar the retrieved content item is to the keywords. Any suitable technique for comparing the keywords to the content record may be used. For example, the raw content or the body text stored in the content record may be analyzed using a term frequency-inverse document frequency (TF-IDF) technique to determine whether any of the keywords are uniquely associated with the content record (compared to other content records), thus making the content record more contextually relevant. As another example, a length of a field that matches a keyword may be considered, such that a keyword that is found in a relatively a short field may be considered be a better indicator of contextual relevance than a keyword that is found in a relatively long field. As another example, a keyword that matches in specified field (such as a title or a hashtag) may be weighted as more contextually relevant than a keyword that matches in another specified field (such as body text). As still another example, a content item may be considered more contextually relevant if a keyword matches a determined topic of the content record. Score components based on one or more of these techniques may be separately weighted and then combined together to create the contextual relevance score.

Next, at block 310, the content scoring engine 110 queries the monitored communication data store 118 to retrieve information regarding communication related to the content item during the time range. In some embodiments, the information regarding communication may include information from multiple communication networks 104, and/or may include multiple types of communication from at least one of the communication networks 104, such as information regarding shares, likes, and/or comments from Facebook and/or the like.

At block 312, the content scoring engine 110 determines at least one static content score based on the information regarding communication during the time range. The static content score indicates a change in a count of communications for the content item during the time range. Any suitable interpretation of the count of communications for the content item may be used. For example, an overall change in the count of communications may be used, such as simply adding counts of all communications during the time range. For example, 5 likes, 10 shares, and 3 comments relating to the content item on Facebook, along with 10 tweets, 5 retweets, 5 favorites relating to the content item on Twitter, and 3 pins of the content item on Pinterest, may be combined to create a static content score of 38 for the time range. In some embodiments, more nuance may be used to determine static content scores for different communication activities. As one example, different communication types on a given communication network may be totaled separately and weighted differently. Accordingly, a share on Facebook may be counted twice as much as a like on Facebook. As another example, the quality of communications may be considered in an amount of weight provided. In this case, a share on Facebook that has 10 associated comments may be weighted more heavily than a share on Facebook that has only two associated comments. In some embodiments, similar communications on separate communication networks 104 may be counted together. For example, all “comments” on all communication networks 104 may be counted together in a single static content score. Other factors, such as a total amount of communication relating to the content source 102, the size of the content source 102, and the overall topic popularity within the tracking set may also be considered in determining the at least one static content score for the content item.

At block 314, the content scoring engine 110 determines at least one dynamic content score based on a rate of change of the information regarding communication during the time range. Because the communication monitoring engine 112 repeatedly queries the communication networks 104 for relevant information and stores it in the monitored communication data store, the content scoring engine 110 can use the stored information to compare the queried time range to a previous sampled time range, or to compare sub-ranges within the requested time range, in order to determine rates of changes of communication relating to the retrieved content item. The content scoring engine 110 may determine the at least one dynamic content score based on how a communication count for the retrieved content item has changed for the time range; how metrics related to the digital content source 102 (such as a total amount of communication relating to the digital content source 102) have changed for the time range; how a score related to a topic of the content item has changed for the time range; and/or any other suitable metric. In some embodiments, the content scoring engine 110 may consider how a static content score and/or a combined content score for the content item has changed over the time range.

The method 300 then proceeds to a continuation terminal (“terminal A”), and then from terminal A (FIG. 3B) to block 316, where the content scoring engine 110 combines one or more of the at least one contextual relevance score, the at least one static content score, and the at least one dynamic content score to determine an overall content score for the content item. In some embodiments, the content scoring engine 110 may simply add the individual scores to determine the overall content score. In some embodiments, the content scoring engine 110 instead applies a heuristic weighting to each of the scores before combining. For example, the content scoring engine 110 may provide twice as much weight to the dynamic content score and three times as much weight to the contextual relevance score in order to generate an overall content score that favors content that is both relevant to the keywords and became more popular during the time range. As another example, if separate static content scores are provided for different types of communication on a given communication network 104, different weights may be applied to each of the separate static content scores (e.g., a Facebook comment may be weighted to be worth twice as much as a Facebook like). Examples of heuristic weights that may be applied by embodiments of the present disclosure include, but are not limited to, communication network 104 preference (e.g., providing more weight to communication on a given communication network 104); communication type preference (e.g., a communication that requires entry of text/engagement is weighted higher than a mere affinity indicator); content source preference (e.g., providing more weight for retrieved content items obtained from a first type of content source 102, such as a newsletter, instead of a second type of content source 102, such as an RSS feed); domain vertical preference (e.g., providing more weight for retrieved content items obtained from a content source 102 relating to “food” as opposed to a content source 102 relating to “fitness”); and content type (e.g., providing more weight for retrieved content items that are videos as opposed to text). In some embodiments, the heuristic weights may be configurable by an administrator or other authorized user of the content analysis system 106. In some embodiments, the heuristic weights may automatically be changed or determined over time using a machine learning algorithm.

In some embodiments, the raw overall content score thus calculated may be used as it is. In some embodiments, the raw overall content score may be normalized to a standard scale (such as between 0 and 1, or between 0 and 100). In some embodiments, the raw overall content score may be compared to a previous raw overall content score, and a delta may be determined. In some embodiments, the content scoring engine 110 may store the determined overall content score that was calculated for the content item for later use, or could just provide the overall content score in a response to the scoring request.

The method 300 then proceeds to the for loop exit block 318. If further content items associated with the tracking set definition remain to be processed, then the method 300 proceeds to a continuation terminal (“terminal B”), and from terminal B (FIG. 3A) returns to the for loop entry block 304. Otherwise, if all content items have been processed, then from the for loop exit block 318 (FIG. 3B) the method 300 proceeds to optional block 320, where the content scoring engine 110 determines an overall content score for the set of content items as a whole, based on the separate overall content scores of the content items. The actions of block 320 are described as optional because in some embodiments, content items from a tracking set may be scored separately, and a combined score for the tracking set may not be produced. Creating an overall content score for the set of content items as a whole has the same granularity for the combined score as for the tracking set itself. Accordingly, as was discussed above with respect to establishing the tracking set definition, a combined score could be established for an entire domain, for a subdomain or other portion of a web site, a group of domains, an industry vertical, and/or the like. In some embodiments, the overall content score for the set of content items as a whole may be determined by combining the raw overall content scores for each content item; by combining normalized forms of the raw overall content scores; by re-weighting the raw overall content scores based on any suitable factor, and/or the like. The method 300 then proceeds to an end block and terminates.

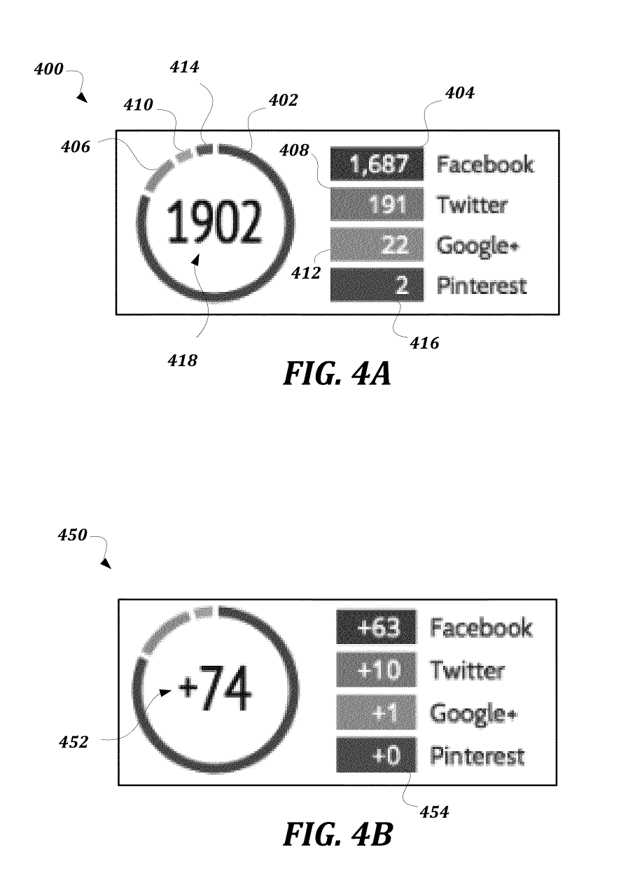

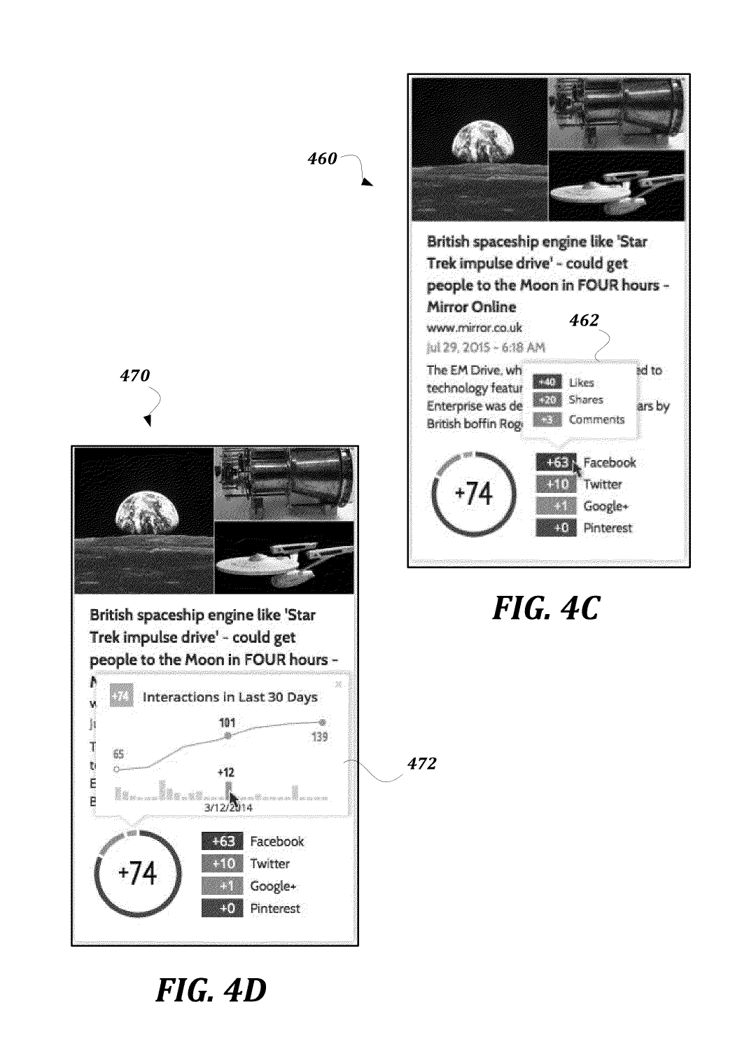

FIGS. 4A-4D are illustrations of exemplary embodiments of presentations of content scores and their component parts according to various aspects of the present disclosure. In FIG. 4A, a content score display 400 includes a raw overall content score 418. A simple heuristic is used in the display 400 in which the raw overall content score is determined using a total number of equally weighted communications during the time frame on each of four equally weighted communication networks 104. The raw overall content score 418 is illustrated in the middle of a ring chart, wherein the segments of the ring chart 402, 406, 410, 414 correspond to the boxes 404, 408, 412, 416 that contain the content scores for each communication network 104 separately. As illustrated, a color of each segment matches a color of the corresponding box (for example, the color of segment 402 matches the color of box 404) in order to provide an easy visual correlation between the ring chart and the numeric information. Further the sizes of the segments of the ring chart 402, 406, 410, 414, may proportionally reflect the influence each of the communication networks 104 has on the overall content score 418, but the sizes may have a minimum in order to allow even a comparably negligible number (such as the number illustrated in box 416) to be visible in the ring chart (such as corresponding segment 414).

In FIG. 4B, a content score display 450 similar to content score display 400 is illustrated. However, in content score display 450, relative overall content scores are used for the time frame instead of the raw overall content scores illustrated in display 400. The illustrated overall content score 452 indicates a number of new communications that occurred during the time period, and the numbers in the boxes include similar information. One will note that the last box 454 now includes a zero content score. The content score display 450 retains the box despite the zero content score in order to indicate that the communication network 104 was considered, but nevertheless had no relevant communication.

In FIG. 4C, a content item display 460 is shown that includes a content score display. The content item display 460 includes at least some of the portion of the content item that was saved in the retrieved content data store, such as several thumbnail images, a title, a domain, a timestamp, and a description. The content item display 460 also illustrates mouse-over functionality provided in the box. Once a box is moused-over, a callout 462 is presented that includes information regarding the basis for the overall content item score. In the illustrated case, a +63 score for Facebook is shown in the callout 462 as including +40 likes, +20 shares, and +3 comments. FIG. 4D is similar, but the content item display 470 shows a callout 472 displayed upon mousing-over or clicking on the overall content score or ring chart. The callout 472 includes trending information that indicates how the content scores have changed for the content item over the time range.

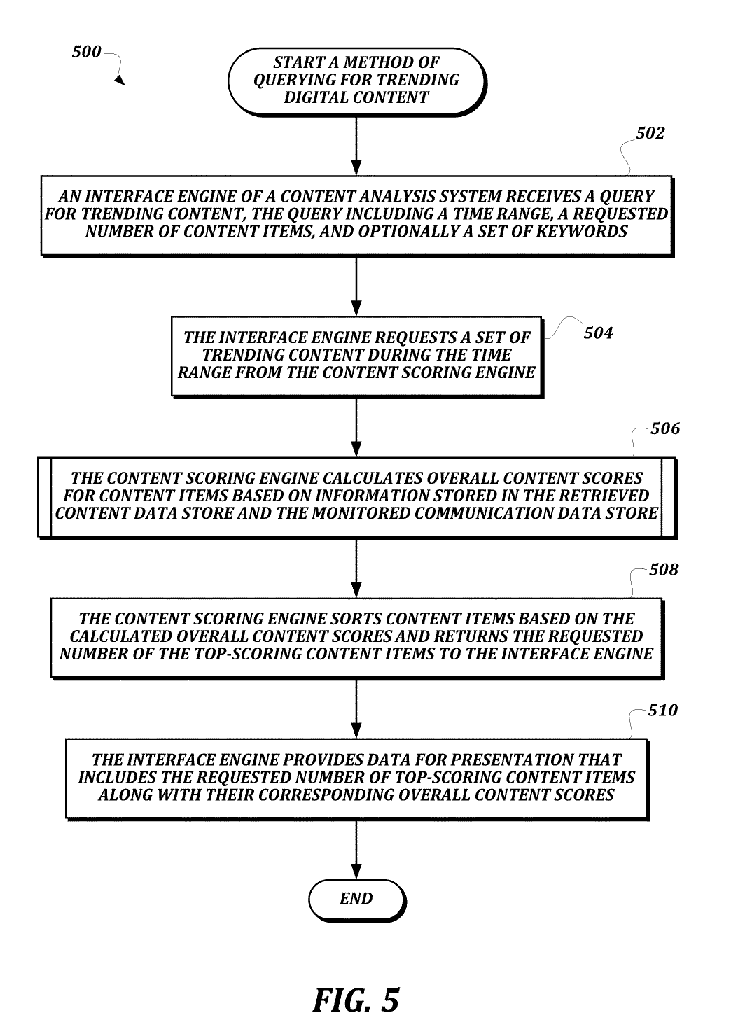

FIG. 5 is a flowchart that illustrates an exemplary embodiment of a method of querying for trending digital content according to various aspects of the present disclosure. As illustrated and described, the method 500 assumes that content items have previously been retrieved by the content retrieval engine 108, and communication has previously been monitored by the communication monitoring engine 112. However, the method 500 does not assume that content scores have already been calculated, as will be discussed further below.

From a start block, the method 500 proceeds to block 502, where an interface engine 120 of a content analysis system 106 receives a query for trending content, the query including a time range, a requested number of content items, and optionally a set of keywords. In some embodiments, the query may be received via an API provided by the interface engine 120. In some embodiments, the query may be received via a web page or other GUI generated by the interface engine 120. In such an embodiment, the GUI may include interface elements for specifying query parameters, including but not limited to selectable time ranges such as past day, past three days, past week, past month, past year, all data, a custom timer range, and/or the like; a text input box for receiving a set of keywords; an interface element for selecting a tracking set to be analyzed; and/or the like.

At block 504, the interface engine 120 requests a set of trending content during the time range from the content scoring engine 110. At procedure block 506, the content scoring engine 110 calculates overall content scores for content items based on information stored in the retrieved content data store 116 and the monitored communication data store 118. For procedure block 506, the method 500 uses any suitable method for calculating overall content scores, such as method 300 as illustrated and described above. In some embodiments, the method 300 could have previously performed some or all of its steps before execution of the method 500. For example, portions of an overall content score that change only upon new monitoring of communication networks 104 by the communication monitoring engine 112 may have already been calculated and stored by the content scoring engine 110. During method 500, the content scoring engine 110 may generate overall scores that include the precalculated score portions along with contextual relevance scores that correspond to the set of keywords submitted in the query and any updated dynamic content scores for the specified time frame.

Next, at block 508, the content scoring engine 110 sorts content items based on the calculated overall content scores and returns the requested number (e.g., top five, top twenty, etc.) of the top-scoring content items to the interface engine 120. At block 510, the interface engine 120 provides data for presentation that includes the requested number of top-scoring content items along with their corresponding overall content scores. In some embodiments, data for presentation may be provided by the interface engine 120 generating a GUI that includes the data. In some embodiments, the interface engine 120 may provide the data via an API, and the data may then be presented or put to some other use by another system. The method 500 then proceeds to an end block and terminates.

In some embodiments, additional functionality for filtering, sorting, or otherwise manipulating the results may be provided in the query page or with the results. For example, in some embodiments, the results may include topics, authors, or other metadata that are associated with the top scoring content items instead of the content items themselves. In such embodiments, by calculating content scores for the content items to determine trending content items, the content scoring engine 110 by proxy determines trending authors, topics, etc., that are associated with the trending content items. As another example, in some embodiments, the GUI provided by the interface engine 120 may allow a user to change the weights used in combining the elements of the overall content score to surface different content items. In such an embodiment, if a user wanted to find content items that were overall the most communicated, the user may raise the weight provided to the static inputs; likewise, if the user wanted to find content items that are recently trending, the user may raise the weight provided to the dynamic inputs. Other weights could be manipulated in order to include or exclude various communication networks; highlight interactive content by giving more weight to communication that has an interactive aspect versus mere affinity indicators; and/or the like. Because some score components are calculated at query time and some are calculated at retrieval time, the content analysis system 106 can generate highly relevant results while also providing fast query performance.

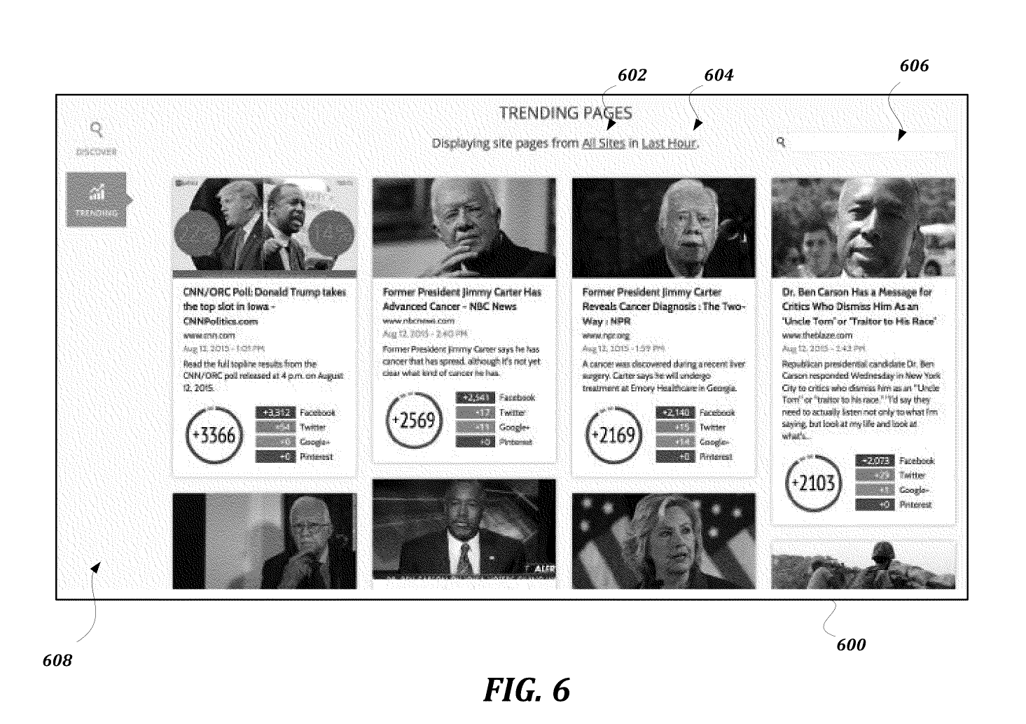

FIG. 6 is an illustration of an exemplary embodiment of a query result display generated by the interface engine according to various aspects of the present disclosure. The display 600 is presenting a set of top scoring content items in a tile format 608. The query specified a tracking set definition that included various news domains, and so the results are the highest scoring content items from those content sources 102. The display 600 also includes a content filter 602 to allow various types of content sources 102 to be included or excluded, a time range specifier 604, and a keyword input box 606. Interaction with any of these interface elements 602, 604, 606 may cause a new query to be created with the updated query parameters, for new content scores to be calculated, and new results to be returned.

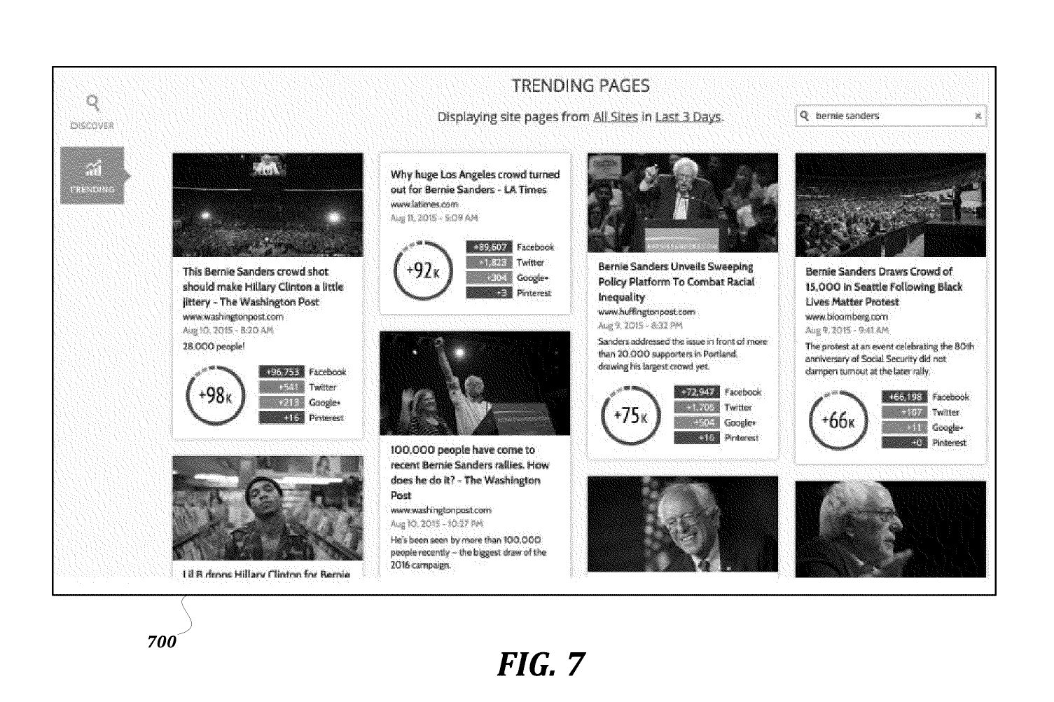

FIG. 7 is another illustration of an exemplary embodiment of a query result display generated by the interface engine according to various aspects of the present disclosure. The display 700 shows results similar to those in display 600 in that the query was submitted for a tracking set definition that included various news domains, and the results are presented in a tile format. However, in display 700, the query was submitted for a time range of three days (instead of one hour), and with keywords for narrowing down the content. Accordingly, only content items relevant to the keywords are included in the results.

In some embodiments of a search results interface, different scoring weights may be used for ranking the content items than are presented in the interface. For example, it may be more intuitive to present content scores that are based on unweighted static inputs (as illustrated in FIGS. 6 and 7), even if more complicated content score weightings are being used to surface trending content items (such as giving more weight to the dynamic inputs, or more weight to content sources with broader reach).

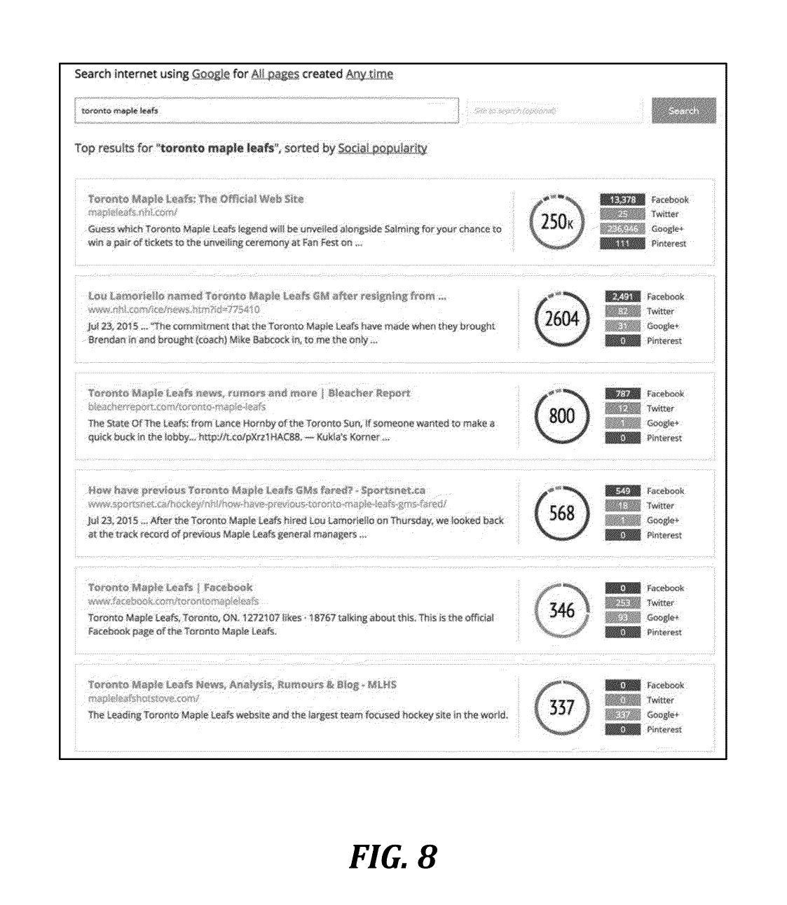

FIG. 8 is an illustration of another exemplary embodiment of a query result display generated by the interface engine according to various aspects of the present disclosure. In FIG. 8, a tracking set was defined using the result of a search conducted by a search engine. Accordingly, the content items retrieved corresponded to the search results provided by the search engine. The communication monitoring engine 112 then monitored communication networks 104 for the content items and the content scoring engine 110 determined overall content scores for the content items, as described above. The content items corresponding to the search results were then re-ranked according to the overall content scores, thus providing search results that are both highly relevant (from an information retrieval standpoint) and highly popular (from a communication standpoint).

Using embodiments of the content analysis system 106 as described above allows for many useful applications. For example, one can identify popular content within a given time frame, and can also identify content that has an accelerating popularity. As another example, trending behavior for one time frame can be compared to trending behavior from a different time frame in order to determine trends that may repeat over time. As still another example, trending content on competitor content sources may be efficiently monitored. Another example is that future performance of content items may be forecast based on previous performance of similar content in the past. Such forecasts could be combined with keyword searches in order to find content on a given topic that is predicted to trend during a future time frame. Features can also be combined to support complex scenarios. For example, topic detection and trending information can be combined to surface topics or concepts that are trending on a user's own domains, or a user's competitors' domains. Instead of just showing trending content, some embodiments of the present disclosure allow reweighting in order to summarize content pages into themes, sentiments, and topics, and to show trending information in any of these categories. For example, a recipe hosting site may be able to determine that winter dessert recipes hosted on their site are trending up on Facebook. Such detailed and flexible analysis was not available before the present disclosure, and embodiments of the present disclosure allow an entity to perform such analysis for either their own content items or their competitors' content items without requiring the entity to write any programs or do any other development work.

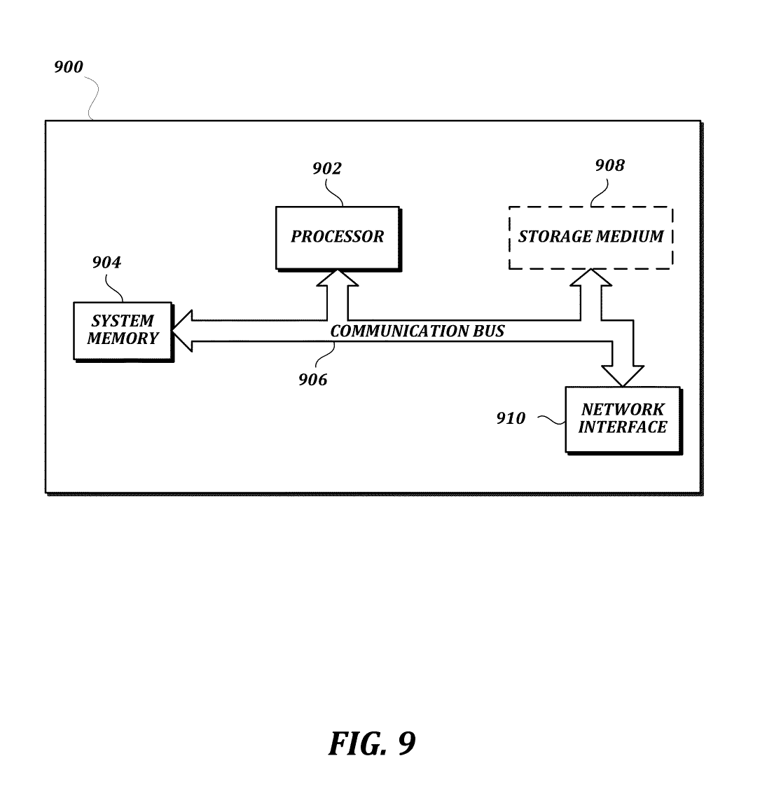

FIG. 9 is a block diagram that illustrates aspects of an exemplary computing device 900 appropriate for use with embodiments of the present disclosure. While FIG. 9 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 900 may be any one of any number of currently available or yet to be developed devices.

In its most basic configuration, the computing device 900 includes at least one processor 902 and a system memory 904 connected by a communication bus 906. Depending on the exact configuration and type of device, the system memory 904 may be volatile or nonvolatile memory, such as read only memory (“ROM”), random access memory (“RAM”), EEPROM, flash memory, or similar memory technology. Those of ordinary skill in the art and others will recognize that system memory 904 typically stores data and/or program modules that are immediately accessible to and/or currently being operated on by the processor 902. In this regard, the processor 902 may serve as a computational center of the computing device 900 by supporting the execution of instructions.

As further illustrated in FIG. 9, the computing device 900 may include a network interface 910 comprising one or more components for communicating with other devices over a network. Embodiments of the present disclosure may access basic services that utilize the network interface 910 to perform communications using common network protocols. The network interface 910 may also include a wireless network interface configured to communicate via one or more wireless communication protocols, such as WiFi, 2G, 3G, LTE, WiMAX, Bluetooth, and/or the like.

In the exemplary embodiment depicted in FIG. 9, the computing device 900 also includes a storage medium 908. However, services may be accessed using a computing device that does not include means for persisting data to a local storage medium. Therefore, the storage medium 908 depicted in FIG. 9 is represented with a dashed line to indicate that the storage medium 908 is optional. In any event, the storage medium 908 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 904 and storage medium 908 depicted in FIG. 9 are merely examples of computer-readable media.

Suitable implementations of computing devices that include a processor 902, system memory 904, communication bus 906, storage medium 908, and network interface 910 are known and commercially available. For ease of illustration and because it is not important for an understanding of the claimed subject matter, FIG. 9 does not show some of the typical components of many computing devices. In this regard, the computing device 900 may include input devices, such as a keyboard, keypad, mouse, microphone, touch input device, touch screen, tablet, and/or the like. Such input devices may be coupled to the computing device 900 by wired or wireless connections including RF, infrared, serial, parallel, Bluetooth, USB, or other suitable connections protocols using wireless or physical connections. Similarly, the computing device 900 may also include output devices such as a display, speakers, printer, etc. Since these devices are well known in the art, they are not illustrated or described further herein.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for analyzing digital content on a network, the system comprising:
at least one computing device configured to provide a content retrieval engine, wherein the content retrieval engine is configured to retrieve content items from one or more content sources;
at least one computing device configured to provide a communication monitoring engine, wherein the communication monitoring engine is configured to query one or more communication networks for information regarding communication related to the retrieved content items; and
at least one computing device configured to provide a content scoring engine, wherein the content scoring engine is configured to determine content scores for the retrieved content items based at least on the information regarding communication related to the retrieved content items.

2. The system of claim 1, wherein retrieving content items from one or more content sources includes:
obtaining, by the content retrieval engine, a tracking set definition, wherein the tracking set definition identifies one or more content sources from which content items are to be retrieved; and
retrieving, by the content retrieval engine via a network, one or more content items from the one or more content sources identified by the tracking set definition.

3. The system of claim 2, wherein retrieving content items from one or more content sources further includes:
storing at least portions of the retrieved one or more content items in content records in a retrieved content data store.

4. The system of claim 3, wherein retrieving content items from one or more content sources further comprises:
extracting metadata from the retrieved one or more content items; and
storing the metadata in the content records.

5. The system of claim 4, wherein the metadata includes at least one of a title, a description, a body text, an author, a video type, a video play length, and a language.

6. The system of claim 4, wherein the metadata includes at least one of a topic and a subject entity.

7. The system of claim 1, wherein querying one or more communication networks for information regarding communication related to the retrieved content items includes receiving information from the one or more communication networks regarding a type and a number of communication events related to the retrieved content items.

8. The system of claim 7, wherein the one or more communication networks are separate from the one or more content sources.

9. The system of claim 7, wherein querying one or more communication networks for information regarding communication related to the retrieved content items includes periodically repeating queries related to the retrieved content items.

10. The system of claim 1, wherein determining content scores for the retrieved content items includes, for a given content item, determining a contextual relevance score based on metadata extracted from the given content item and one or more keywords.

11. The system of claim 1, wherein determining content scores for the retrieved content items includes, for a given content item, analyzing monitored communication related to the given content item during a given time range.

12. The system of claim 11, determining content scores for the retrieved content items includes, for the given content item, determining at least one of a static content score based on the monitored communication related to the given content item during the given time range and a dynamic content score based on a rate of change of the monitored communication related to the given content item during the given time range.

13. The system of claim 1, wherein determining content scores for the retrieved content items includes, for a given content item, combining a contextual relevance score, a static content score, and a dynamic content score to determine an overall content score for the given content item.

14. The system of claim 13, wherein combining the contextual relevance score, the static content score, and the dynamic content score includes applying one or more weights to the scores to alter their contribution to the overall content score.

15. The system of claim 1, further comprising at least one computing device configured to provide an interface engine, wherein the interface engine is configured to provide information for presentation that includes overall content scores.

16. The system of claim 15, wherein the interface engine is further configured to receive queries for trending content items and to provide information about trending content items for presentation based on overall content scores determined by the content scoring engine.

17. A computer-implemented method for identifying trends on a network, the method comprising:
retrieving, by a computing device, a set of content items from one or more content sources via a network;
monitoring, by a computing device, communication related to the retrieved set of content items on one or more communication networks during a given time frame;
determining, by a computing device, a score for each content item of the retrieved set of content items based at least on the monitored communication during the given time frame; and
presenting, by a computing device, an interface based on the retrieved set of content items having highest scores.

18. The method of claim 17, wherein determining a score for each content item includes:
extracting metadata from the content item;
comparing the metadata to one or more keywords; and
basing the score at least in part on the comparison of the metadata to the one or more keywords.

19. The method of claim 17, wherein determining a score for each content item includes:
counting a first number of communication events in the monitored communication of a first type and a second number of communication events in the monitored communication a second type; and
adding a first value to the score for the first number of communication events and adding a second value to the score for the second number of communication events;
wherein the first value is based on the first number and a first weight; and
wherein the second value is based on the second number and a second weight different from the first weight.

20. The method of claim 17, wherein presenting an interface based on the retrieved set of content items having highest scores includes:
determining at least one of a set of topics and a set of authors of the retrieved set of content items having highest scores; and
presenting the at least one of the set of topics and the set of authors as trending topics or authors.
